(19) United States
(12) Patent Application Publication
(10) Pub. No.: US 2007/0294065 A1
(43) Pub. Date: Dec. 20, 2007

(54) METHOD, APPARATUS, AND COMPUTER PROGRAM PRODUCT FOR IMPLEMENTING PLANS FOR LOGICAL PARTITION (LPAR) SYSTEMS

(76) Inventors: David J. Gimpl, Rochester, MN (US); Cale T. Rath, Byron, MN (US); George James Romano, Rochester, MN (US); Tammy Lynn Van Hove, Elgin, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/421,329

(22) Filed: May 31, 2006

(51) Int. Cl. G06G 7/48

(52) U.S. Cl. 703/6

(57) ABSTRACT

A method, apparatus and computer program product for implementing plans for logical partition (LPAR) systems includes the generation of a representation of existing hardware and LPAR configuration of a system that is used as input for further LPAR planning and configuration modeling to enable producing accurate and valid plans for possible deployment. The existing system is surveyed and the representation of existing hardware and LPAR configuration of the system is generated. The representation is applied to a partition planning tool and used to create a plan for the LPAR system.

### FIELD OF THE INVENTION

The present invention relates generally to the data processing field, and more particularly, relates to a method, apparatus, and computer program product for implementing plans for logical partition (LPAR) systems.

### DESCRIPTION OF THE RELATED ART

LPAR solutions can be planned with sophisticated partition planning tools. These planning tools can configure and simulate the rules of complex hardware environments.

Partition planning tools enable specific system hardware to be modeled to allow accurate validation of a proposed partition configuration on a precise configuration of system hardware. The planning tool can represent the system and validate the partition layout, the resulting validated system hardware and partition plan can then be used to build the modeled system and deploy the planned partitions when that system is manufactured.

A significant problem is that for existing systems, their hardware configurations must be accurately represented inside the planning tool to allow the planning session to be valid. Currently the process of trying to precisely describe an existing system's complex hardware configuration to a partition planning tool is a tedious and error prone task. There cannot be any appreciable deviation between the existing system's configuration and the system hardware that is modeled within the partition planning session to configure that existing system's partitions.

If the model of the actual system is not accurate that means that the resulting plan, while valid for the system represented in the plan, might not be valid or even deployable on the actual system. For example, if a system input output (IO) controller card is out of place, or that card is unsupported for a partition operating system type that was configured to use it, or if that IO controller is not even there on the system where a validated partition plan is to be deployed, then that plan could not be deployed on that system.

In addition to a partitionable system's hardware configuration, the system might already have partitions defined that must be considered in any planning session that would further partition the system. As with existing system hardware, there are an extremely large number of ways that a given system can be partitioned. The partition's attributes and inter-partition dependencies possible through virtual connections make the configuration even more complex.

If an administrator using the partition planning tool needs to revise or add to an existing partition configuration on existing hardware or is attempting to revise and then validate the existing partition configuration then, the existing partitions and any relationships between existing partitions, between those partitions and existing hardware, and configurations attributes of each partition has to be precisely represented as input into the planning session. An administrator could possibly manually configure existing system's partitions so that they can be part of the planning session and be represented in the ultimate, validated, partition plan that results from the planning tool session. As with attempting to describe that system's existing hardware, re-describing that system's existing partition configuration precisely as it is currently defined is both an error prone and a tedious part of the start of a partition planning session.

A need exists for an effective mechanism for implementing plans for logical partition (LPAR) systems.

### SUMMARY OF THE INVENTION

Principal aspects of the present invention are to provide a method, apparatus and computer program product for implementing plans for logical partition (LPAR) systems. Other important aspects of the present invention are to provide such method, apparatus and computer program product for implementing plans for logical partition (LPAR) systems substantially without negative effect and that overcome many of the disadvantages of prior art arrangements.

In brief, a method, apparatus and computer program product are provided for implementing plans for logical partition (LPAR) systems. A round tripping method includes the generation of a representation of existing hardware and LPAR configuration of a system that is used as input for further LPAR planning and configuration modeling to enable producing accurate and valid plans for possible deployment. The existing system is surveyed and the representation of existing hardware and LPAR configuration of the system is generated. The representation is applied to a partition planning tool and used to create a plan for the LPAR system.

In accordance with features of the invention, partitions are deployed on the existing LPAR system from the created plan using a partition deployment tool. Since the round tripping method begins by surveying the existing system and using a description of that system as input, the planned and validated partitions are assured of working on the actual existing hardware when the plan for those partitions is deployed on that existing system.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1 and 2 are block diagram representations illustrating an exemplary computer system and operating system for implementing methods for implementing logical partition (LPAR) plans for computer systems in accordance with the preferred embodiment;

FIGS. 3, 4, 5, 6, and 7 are flow charts illustrating exemplary steps of methods for implementing logical partition (LPAR) plans for computer systems in accordance with the preferred embodiments;

FIG. 8 is a block diagram illustrating a computer program product in accordance with the preferred embodiment.

### DETAILED DESCRIPTION OF THE PREFERRED EMBODIMENTS

In accordance with features of the invention, an LPAR round tripping method allows actual existing systems to be used in a planning tool to describe and validate the relationships of partitions to hardware. Since the round trip begins by surveying the existing system and using a description of that system as input, the planned and validated partitions are assured of working on the actual existing hardware when the plan for those partitions is deployed on that existing system.

In accordance with features of the invention, the round tripping method enables presenting information generated about an existing system's hardware and partition layout in a file format. This is the same format as would have been used to deploy that same system partition on the system's hardware layout. This deployable representation can be therefore used as input to a planning session that can revise these kinds of deployment plans. A partition planning tool uses this information generated about an existing system's hardware and partition layout that is conveyed via a file to the planning tool. The planning tool has an accurate representation as a starting point for system hardware and partition planning. There is no need for the administrator using the planning tool to have to create this representation as it was generated by the invention. Within the planning session the hardware and partition layout can be manipulated by using the planning tool's internal representation of the information generated in accordance with the invention. The logical representation of the system and its partitions can be modified and added to. Since the planning tool can validate any change made, the round tripped representation of an existing system provides a powerful means to test out and plan revisions to that existing system's hardware and partition layout, and also as a mechanism to extend or modify LPAR plans to be reused on other partitionable systems.

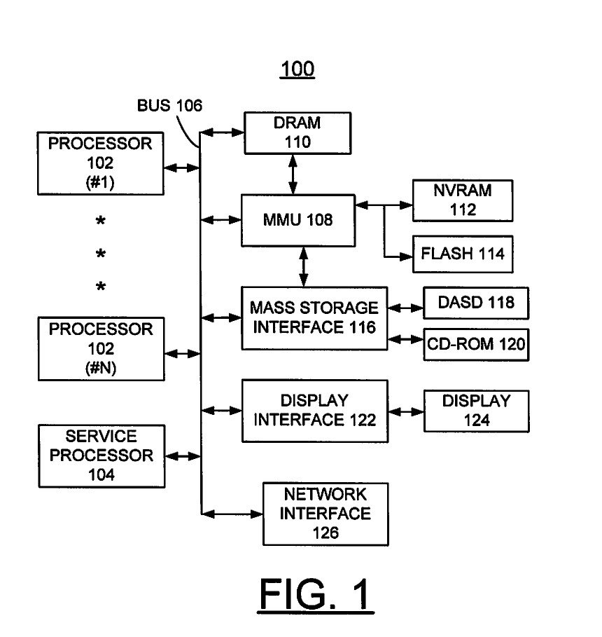

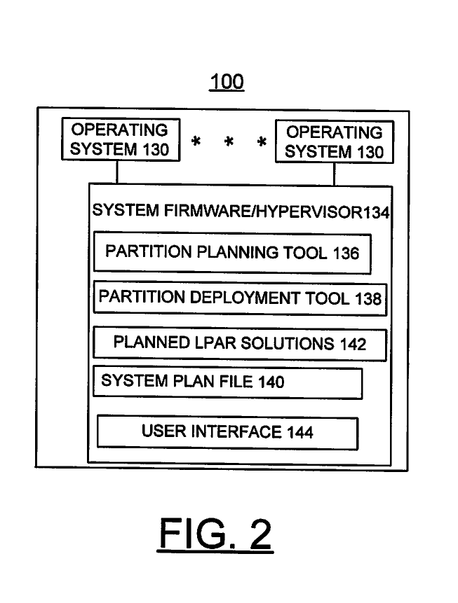

Referring now to the drawings, in FIGS. 1 and 2 there is shown an exemplary computer system generally designated by the reference character 100 for implementing methods for generating enhanced LPAR plans in accordance with the preferred embodiment. Computer system 100 includes a plurality of processors 102, #1-N or central processor units (CPUs) 102, #1-N and a service processor 104 coupled by a system bus 106 to a memory management unit (MMU) 108 and system memory including a dynamic random access memory (DRAM) 110, a nonvolatile random access memory (NVRAM) 112, and a flash memory 114. The system bus 106 may be private or public, and it should be understood that the present invention is not limited to a particular bus topology used. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a network interface 126 coupled to the system bus 106.

Computer system 100 is shown in simplified form sufficient for understanding the present invention. The illustrated computer system 100 is not intended to imply architectural or functional limitations. The present invention can be used with various hardware implementations and systems and various other internal hardware devices.

As shown in FIG. 2, computer system 100 includes a plurality of operating system 130, and a system firmware or hypervisor 134 of the preferred embodiment, a partition planning tool 136, a partition deployment tool 138, a system plan file 140, and a plurality of planned LPAR solutions 142 of the preferred embodiment and a user interface 144.

In accordance with features of the invention, the round tripping method allows an existing partitionable system's current hardware and partition configuration to be used as a basis to generate a precise description of that configuration with the intention to be used in a partition planning tool 136. The generated representation advantageously is used as input to the partition planning tool 136 as a starting point for planning a new or revised partition plan for the system. The description, because it is an accurate representation, allows the LPAR planning session to configure and validate new or revised partition plans to fit that exact system hardware. If there are existing partitions on that system, this description allows the existing partitions to be represented within that same planning session. The planning session starts with an exact representation of the system that is being planned as its starting point. That system description can be revised within the planning tool and the resulting validated partition layout plan saved into the same abstract form. This output from the planning session can possibly be returned to the original system to be deployed there. The system configuration information completes a cycle from generation using an actual system to planning session revision and then deploying back to the original source system, hence the term “round tripping”.

In accordance with features of the invention, the round tripping method allows the validated abstract plan to actual partition layout deployment on a real system to be reversed. An existing system that has been partitioned, with an available partitioning tool, such as POWER5 Hypervisor Management Console or EMC Company's VMWare, advantageously is extended with the invention to support the existing system being managed to be probed for its current hardware configuration. Furthermore that same partitionable system could optionally also be probed to determine the partitions configured on that system hardware, the attributes of these partitions, how these partitions are configured to use the existing system's hardware, and how the partitions might be related to each other through virtual connection and virtual storage adapters. The probe information is formatted and stored in an internal memory model that advantageously is used to create a precise file representation of that system hardware and any configured partitions.

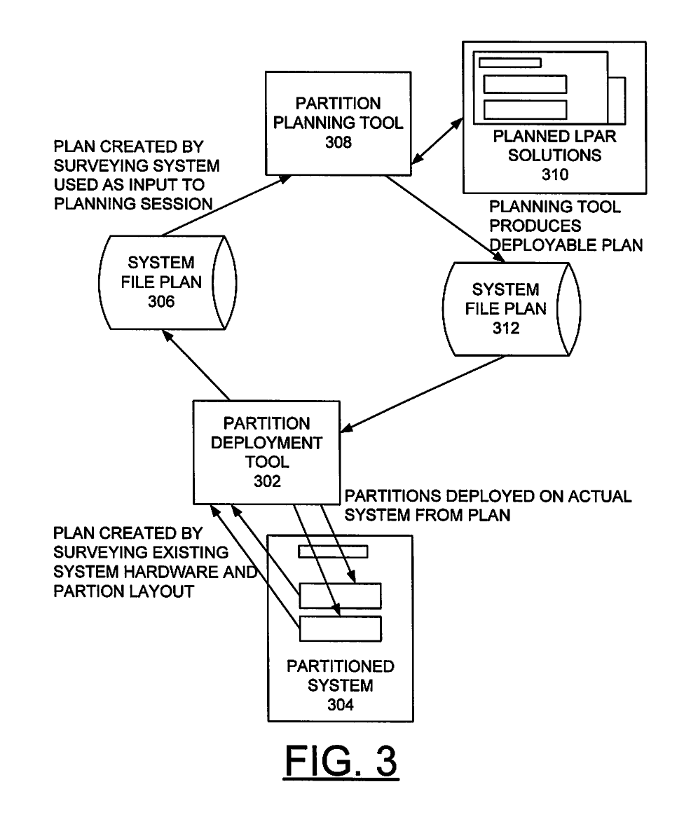

Referring now to FIG. 3, there are shown exemplary steps of a round tripping method for generating enhanced LPAR plans in accordance with the preferred embodiment. First a partition deployment tool as indicated in a block 302 surveys an existing partitioned system as indicated in a block 304 As indicated in a block 306, a first system plan file 140 is created using the surveyed existing system hardware and partition layout. The system plan file created by surveying the existing system is input to a partition planning tool 136 as indicated in a block 308. The partition planning tool 136 is used to revise a planned layout of partitions, hardware and how the partitions and hardware are related or planned LPAR solutions 142 as indicated in a block 310 and the planning tool produces a deployable plan or second system plan file as indicated in a block 312. The deployable plan 312 or second system plan file 140 is applied to the partition deployment tool 138 at block 302 and partitions are deployed on actual system from the plan at block 304.

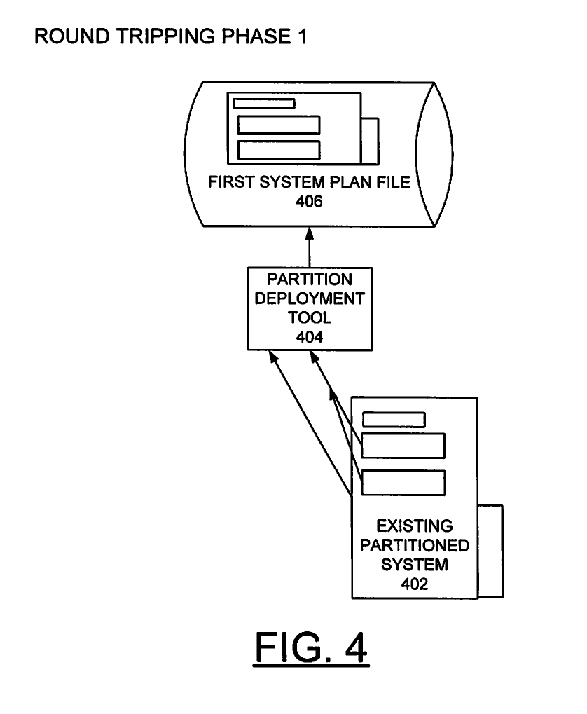

Referring now to FIG. 4, there are shown exemplary steps of the round tripping phase 1 of the round tripping method of FIG. 3. An existing partitioned system 402 is surveyed. Surveyed information for the existing partitions, hardware and relationships are applied to the partition deployment tool 138 as indicated in a block 404. As indicated in a block 406, first system plan file 140 is created with the existing partitions, hardware and relationships being stored in a format that can be used to plan partitions, hardware and how the partitions and hardware are related.

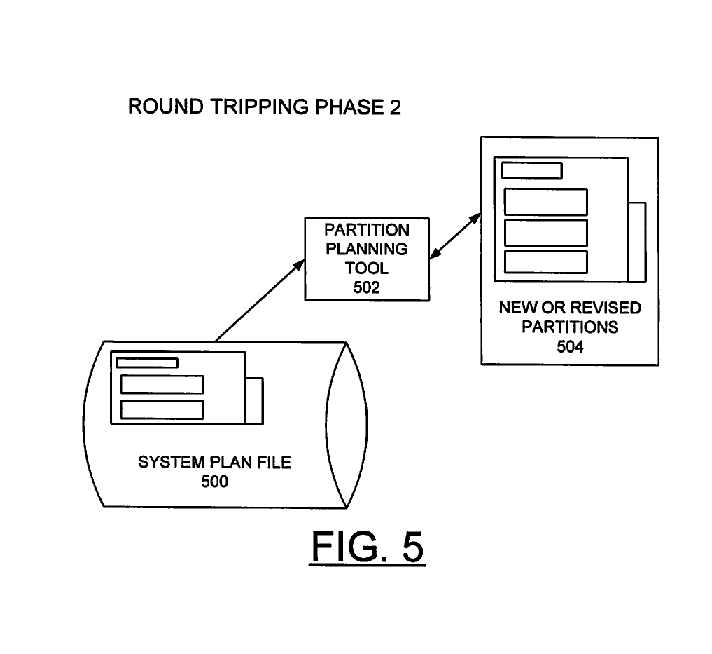

Referring now to FIG. 5, there are shown exemplary steps of the round tripping phase 2 of the round tripping method of FIG. 3. As indicated in a block 500, the first system plan file 140 that was created using the existing partitions, hardware and relationships are applied to the partition planning tool 136. The system planning tool or partition planning tool 136 as indicated in a block 502 is used to revise the planned layout of partitions, hardware and how the partitions and hardware are related. The partition planning tool 136 is used to produce a valid plan of partitioning the system hardware that was configured in the content of the first system plan file 140. The new or revised layout of partitions, hardware and how the partitions and hardware are related are stored as indicated in a block 504. In the round tripping phase 2, the plan is an actual existing system.

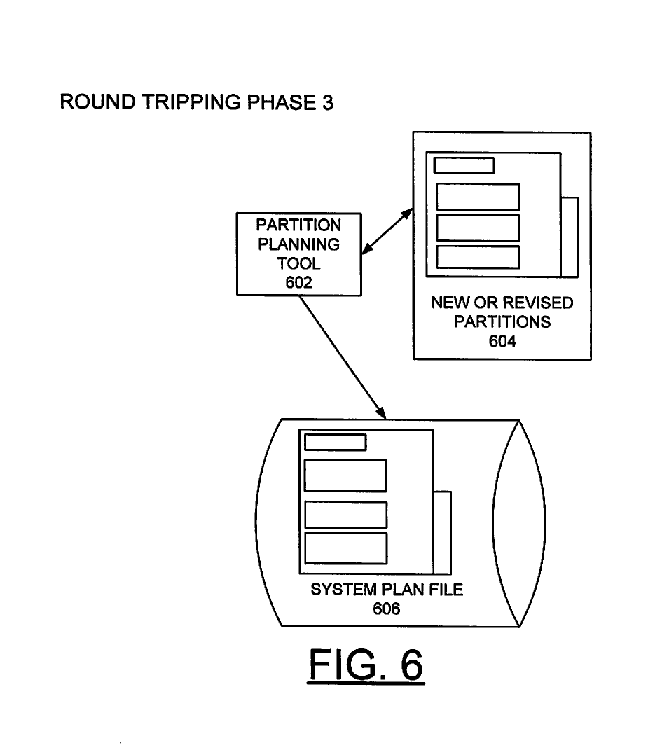

Referring now to FIG. 6, there are shown exemplary steps of the round tripping phase 3 of the round tripping method of FIG. 3. As indicated in a block 602, the system planning tool 136 is used to revise the planned layout of partitions, hardware, and how the partitions and hardware are related as indicated in a block 604. Planning tool 136 assures the partitions are valid and will function on the hardware image defined. In this case of the round tripping method, the hardware image used in the planning session is the existing system that was used at the start of the round trip in phase 1. The plan created or revised by the partition planning tool 136 is output from the planning session. The system plan file as indicated in a block 606 reflects the partitions and there relationship to the actual system hardware.

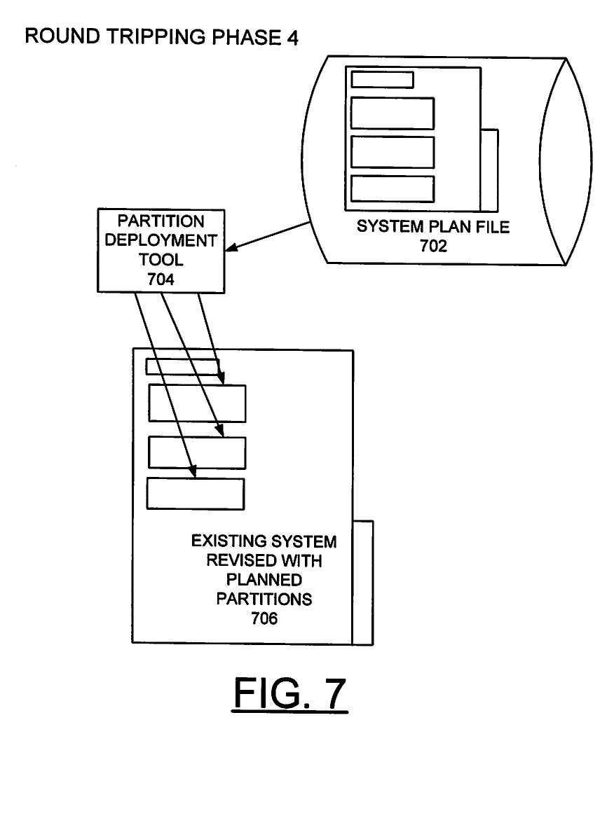

Referring now to FIG. 7, there are shown exemplary steps of the round tripping phase 4 of the round tripping method of FIG. 3. System planning has revised the planned layout of the partitions, hardware and how the partitions and hardware are related. Because the original system plan that was used in the planning session was derived from the existing system and partition layout validated in the planning tool, the round tripping method assures that the plan of partitions will deploy and is valid on the existing system hardware where the round trip began. As indicated in a block 702, the system plan file 140 that was created using the existing partitions, hardware and relationships are applied to the partition deployment tool 138.

The partition deployment tool 138 as indicated in a block 704 uses the applied system plan 140 to partition the existing system. The existing system is revised with the planned partitions as indicated in a block 706.

In accordance with features of the invention, the capability to precisely represent the actual system hardware and partitions in an abstract form also allow for support of other tools to possibly utilize this same format as input. This support can include multiple forms of report generation, hardware upgrade planning and capacity planning, service and support documentation, partition consolidation, hardware consolidation, partition migration, hardware and partition inventory and tracking, and duplication of system configuration and deployment to like hardware, for example, cloning a complex configuration of partitions on an exact or close copy of the original system hardware.

The same form of system hardware and partition layout used to hold the generated information about the system is used for deployment, and can be fed with some revisions back into the original system, distributed to another similar system or multiple systems, or used to produce new manufactured systems that can effectively serve as clones or precise copies of an original system's hardware and partition layout.

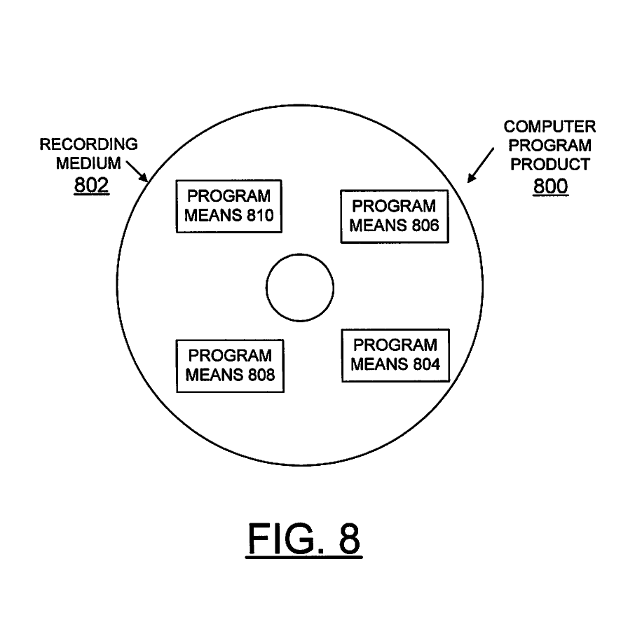

Referring now to FIG. 8, an article of manufacture or a computer program product 800 of the invention is illustrated. The computer program product 800 includes a recording medium 802, such as, a floppy disk, a high capacity read only memory in the form of an optically read compact disk or CD-ROM, a tape, a transmission type media such as a digital or analog communications link, or a similar computer program product. Recording medium 802 stores program means 804, 806, 808, 810 on the medium 802 for carrying out the methods for implementing LPAR plans of the preferred embodiment in the system 100 of FIG. 1.

A sequence of program instructions or a logical assembly of one or more interrelated modules defined by the recorded program means 804, 806, 808, 810, direct the computer system 100 for implementing LPAR planning methods of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A computer-implemented method for implementing plans for logical partition (LPAR) systems comprises the steps of:
surveying an LPAR system and generating a representation of existing hardware and LPAR configuration of the LPAR system;
applying said generated representation to a partition planning tool; and
said partition planning tool creating a plan for the LPAR system using said generated representation.

2. The computer-implemented method as recited in claim 1 includes providing a partition deployment tool with the LPAR system, and wherein surveying the LPAR system is performed by said partition deployment tool.

3. The computer-implemented method as recited in claim 2 further includes using said partition deployment tool for deploying partitions on the LPAR system from the created plan.

4. The computer-implemented method as recited in claim 1 further includes deploying partitions on the LPAR system from the created plan.

5. The computer-implemented method as recited in claim 1 wherein generating said representation of existing hardware and LPAR configuration of the LPAR system includes generating a system plan file.

6. The computer-implemented method as recited in claim 5 wherein applying said generated representation to a partition planning tool includes applying said system plan file to said partition planning tool.

7. The computer-implemented method as recited in claim 5 wherein said partition planning tool creating a plan for the LPAR system using said generated representation includes said partition planning tool creating said plan for the LPAR system using said system plan file.

8. The computer-implemented method as recited in claim 7 wherein said created plan for the LPAR system includes a deployable system plan file for the LPAR system.

9. Apparatus for implementing plans for logical partition (LPAR) systems comprises:
a partition deployment tool for surveying an LPAR system and generating a representation of existing hardware and LPAR configuration of the LPAR system;
a partition planning tool for receiving an input of said generated representation; and
said partition planning tool for creating a plan for the LPAR system using said input of said generated representation.

10. The apparatus as recited in claim 9 further includes said partition deployment tool for deploying partitions on the LPAR system from the created plan.

11. The apparatus as recited in claim 9 wherein said representation of existing hardware and LPAR configuration of the LPAR system includes a system plan file

12. The apparatus as recited in claim 9 wherein said created plan for the LPAR system includes a deployable system plan file for the LPAR system.

13. A computer program product for implementing plans for logical partition (LPAR) systems in a computer system, said computer program product including instructions executed by the computer system to cause the computer system to perform the steps comprising:
surveying an LPAR system and generating a representation of existing hardware and LPAR configuration of the LPAR system;
applying said generated representation to a partition planning tool; and
said partition planning tool creating a plan for the LPAR system using said generated representation.

14. The computer program product as recited in claim 13 further includes deploying partitions on the LPAR system from the created plan.

15. The computer program product as recited in claim 13 further includes providing a partition deployment tool with the LPAR system, and wherein surveying the LPAR system is performed by said partition deployment tool.

16. The computer program product as recited in claim 15 further includes using said partition deployment tool for deploying partitions on the LPAR system from the created plan.

17. The computer program product as recited in claim 13 wherein generating said representation of existing hardware and LPAR configuration of the LPAR system includes generating a system plan file.

18. The computer program product as recited in claim 17 wherein generating said representation of existing hardware and LPAR configuration of the LPAR system includes generating a system plan file.

19. The computer program product as recited in claim 13 wherein said partition planning tool creating a plan for the LPAR system using said generated representation includes said partition planning tool creating a deployable system plan file for the LPAR system.

20. A method for deploying computing infrastructure, comprising integrating computer readable code into a computing system, wherein the code in combination with the computing system is capable of performing the method of claim 1.
